(19) United States
(12) Patent Application Publication
(10) Pub. No.: US 2002/0170681 A1
(43) Pub. Date: Nov. 21, 2002

(54) Letter moistener

(76) Inventors: Alain Saurer, Neuchatel (CH); Stefan Etter, Kehrsatz (CH); Thomas Gasser, Bern (CH)

Correspondence Address: PERMAN & GREEN, 425 POST ROAD, FAIRFIELD, CT, 06430, US

(21) Appl. No.: 10/081,262

(22) Filed: Feb. 21, 2002

Related U.S. Application Data
(60) Provisional application No. 60/270,796, filed on Feb. 23, 2001.
(60) Provisional application No. 60/277,806, filed on Mar. 22, 2001.
(60) Provisional application No. 60/227,841, filed on Aug. 25, 2000.
(60) Provisional application No. 60/227,873, filed on Aug. 25, 2000.
(60) Provisional application No. 60/227,931, filed on Aug. 25, 2000.
(60) Provisional application No. 60/227,946, filed on Aug. 25, 2000.
(60) Provisional application No. 60/338,892, filed on Nov. 5, 2001.

(51) Int. Cl. B43M 3/00

(52) U.S. Cl. 156/441.5; 156/442.2

(57) ABSTRACT

A moistening apparatus for moistening an area containing glue on an envelope flap by continuously supplying water to the glue area. The apparatus comprises a frame member; a support member for moving one envelope at a time with the envelope flap in a partially opened position toward the moistening apparatus; a brush member supported lengthwise within the frame member; and a water supply member in contiguous contact with the brush member and adapted to continuously moisten the entire length of the brush with water.

### CROSS-REFERENCE TO RELATED APPLICATIONS

This application claims priority of the following U.S. provisional patent applications: serial No. 60/270,796 filed on Feb. 23, 2001, serial No. 60/277,806 filed on Mar. 22, 2001, serial No. 60/227,841 filed on Mar. 22, 2001, serial No. 60/227,873 filed on Mar. 22, 2001, serial No. 60/227,931 filed on Mar. 22, 2001, serial No. 60/227,946 filed on Mar. 22, 2001 and serial No. 60/338,892 filed Nov. 5, 2001.

### BACKGROUND OF THE INVENTION

1. Field of the Invention

This invention relates to an apparatus for moistening a glue containing area, and more particularly to a moistening apparatus for moistening the glue containing area of an envelope flap where there is continuously supplied sufficient water to a brush member which in turn, moistens the entire glue portion of an envelope flap.

2. Description of Prior Developments

Mailing machines generally employ an apparatus for moistening and sealing the glue portion of a flap of an envelope prior to the envelope being weighted and metered by a postage meter. There are numerous devices and methods by which an envelope flap can be moistened. For example, there is the simple and probably least expensive type mechanism which employs an envelope flap moistener including a wet brush that is brought into contact with the glue area of the flap of an envelope or a pad formed of a wet wicking material that is brought into contact with the glue. There are also various non-contact envelope flap moisteners that employ a jet or a nozzle which spray a moistening fluid such as water upon the glue area of an envelope flap. These devices tend to be expensive, and generally rather complex in a structural sense.

One very simple prior art type moistening apparatus for moistening the glue containing area of an envelope flap comprises simply a brush that absorbs water from a felt pad that is in turn partially immersed in a tray of water. This type of prior art structure for a moistener is illustrated in FIG. 1. The water is taken up by capillary action on the brush at that point in time during the process when there is no envelope flap being moistened. When the envelope flap 10 is positioned between the pad 11 and brush 12 to be moistened, only the water on the brush could be used to moisten the envelope flap, and the brush does not have it's water replenished until the flap is removed. See the moistener assembly illustrated in FIG. 2. It was discovered that in these kind of prior art moistening devices, there was not always enough moisture on the brush 12 to satisfactorily moisten the entire length of, for example, an envelope flap 10. This was particularly the situation with longer envelopes with long envelope flaps. Thus, the envelope flap would tend to be adequately moistened at the beginning portions thereof, but would become drier and drier as the envelope flap continued to move against the brush. Therefore, many portions of the envelope would not be properly sealed.

It is therefore a primary object of the present invention to provide a relatively inexpensive, efficient and non- complicated (i.e. simple structure) for a moistener for moistening and sealing the flap of an envelope along its entire length of glue.

### SUMMARY OF THE INVENTION

In accordance with the features of the present invention as described herein there is provided an improved moistening apparatus for moistening the glue area of an envelope flap which avoids the above described disadvantages of known moistener apparatus. The present invention provides for the water to be able to be pumped up into a water reservoir that is positioned over a brush member so there is continuously provided to the brush, sufficient water to keep the brush moist at all times (i.e. an endless flow of water). The water is fed to the brush in a controlled fashion and any excess water drops by gravity into a waste water catch tray that is positioned below the moistener assembly and which provides pumping means to allow the water in the catch tray to be recirculated back to the water reservoir for again feeding the water to the brush. This structure for an improved envelope moistener assembly enables the full length of the envelope flap to be evenly moistened even in the situation where there are long envelope flaps and high envelope speed moistening requirements. After the moistening procedure has been completed by a moistening apparatus in accordance with the features of the present invention, the envelope flap is pressed against the envelope to seal the envelope. Upper and lower belt members subsequently transport the sealed envelope away from the moistener assembly.

A moistening apparatus for moistening the area containing glue on an envelope flap in accordance with the features of the present invention comprises a frame member; support member for moving one envelope at a time with the envelope flap in a partially opened position toward the moistening apparatus; a brush member supported lengthwise within the frame member and a water supply member in contiguous contact with the brush member and adapted to continuously moisten the entire length of the brush with water.

An additional embodiment of a moistening apparatus according to the features of the present invention for moistening an area containing glue on an envelope flap by continuously supplying water to the glue area comprises: a frame member; a support member for moving one envelope at a time with the envelope flap in a partially opened position toward the moistening apparatus; a brush member supported lengthwise within the frame member adapted to position elongated portions of the brush to moisten the glue; a water supply member in contiguous contact with the brush member and adapted to continuously moisten the entire length of the brush with water; and a pumping device to pump water from a reservoir tank to the water supply member.

Further in accordance with the embodiments of the present invention there is defined a mailing machine comprising a plurality of processing stations including a processing station for transporting an envelope and a processing station for sealing the envelope, the mailing machine including a moistening apparatus for moistening the area containing glue on an envelope flap in the processing station prior to sealing the envelope, the moistening apparatus comprising a frame member; support member for moving one envelope at a time with the envelope flap in a partially opened position toward the moistening apparatus; a brush member supported lengthwise within the frame member; a water supply member in contiguous contact with the brush member and adapted to continuously moisten the entire length of the brush with water; the mailing machine including an envelope flap support element positioned under the brush member and adapted to force the glue area of the envelope flap against the moist brush member as the envelope moves through the moistening apparatus thereby supplying moisture to the entire length of the glue area on the envelope flap.

### BRIEF DESCRIPTION OF THE DRAWINGS

The foregoing aspects and other features of the present invention are explained in the following description, taken in connection with the accompanying drawings, wherein:

FIG. 1 is a schematic front plan view of a prior art brush type moistening apparatus;

FIG. 2 is a schematic front plan view of the prior art brush type moistening apparatus as illustrated in FIG. 1 specifically showing the envelope flap in place in the moistener apparatus;

FIG. 3 is a schematic front plan view of a brush type moistening apparatus in accordance with the features of the present invention;

FIG. 4 is a schematic top view of the various components that circulate water in accordance with the features of the present invention;

FIG. 5 illustrates the water flow pattern in a moistening device according to the features of the present invention; and

FIG. 6 is a perspective view of a moistening device according to the features of the present invention within a modular feeding unit of a mailing machine system.

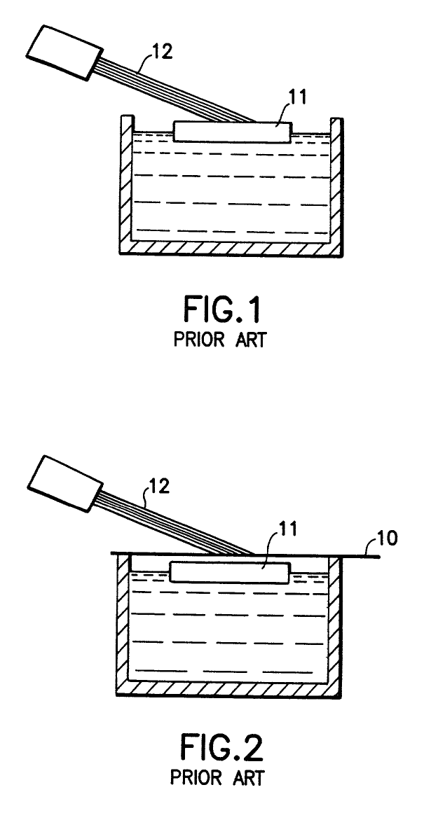

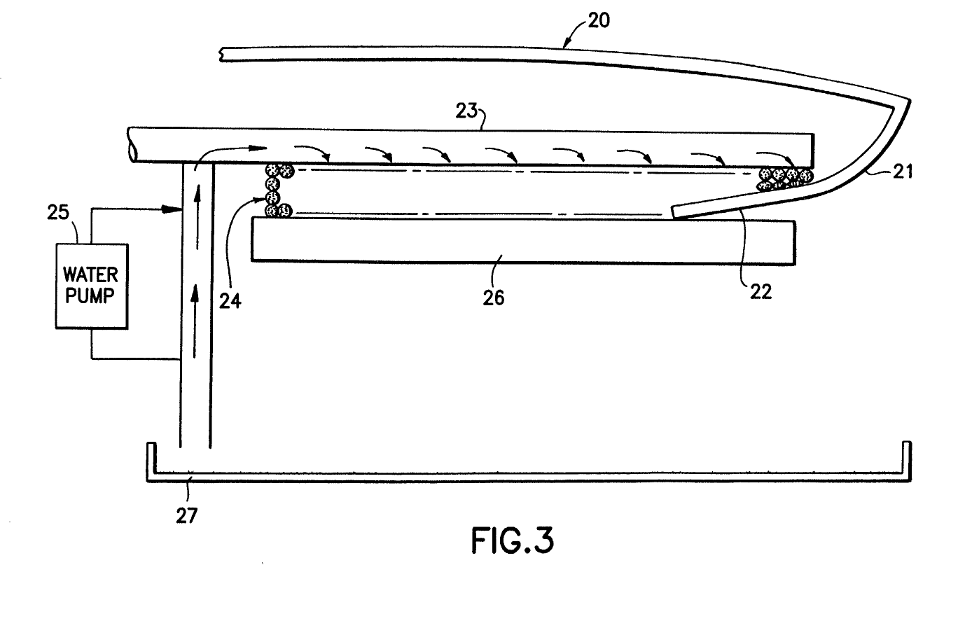

### DESCRIPTION OF THE PREFERRED EMBODIMENTS

As illustrated in FIG. 3, there is shown the basic elements which comprise the moistening apparatus in accordance with the features of the present invention. There is specifically shown an envelope 20 with its flap 21 in an open position exposing the surface 22 of the envelope flap 21 having glue. While in an open position, as shown, the envelope 20 is fed into the moistening apparatus 15 which includes a water supply member 23 in the form of an elongated water reservoir 23 having a plurality of openings or nozzles (not shown) which allow water when fed into the reservoir under pressure to be distributed to a brush member 24 that is supported lengthwise in the moistening apparatus 15. Brush member 24 is supported within moistening apparatus 15 in such a way so as to position the individual brush bristles 24A which make up the brush member 24 to lie in a plane that is substantially parallel to the path of movement of envelope 20. This will permit the elongated surface of the individual brush bristle elements 24A via capillary action to continuously deposit water on the glue surface 22 of flap 21. In accordance with the features of the present invention the brush member could be formed of any material typically used for forming brush bristles or the brush could be made from, for example, felt or a sponge material. Any material could be used to form brush bristles so long as the material would permit water to transfer to the brush by capillary action and then to be transferred to the glue area of the envelope 20 by capillary action. The water is fed continuously throughout the various water flow paths of the moistener in accordance with the features of the present invention by a water pump 25 which keeps the water continuously circulating in the moistener. A support member 26 keeps the glue surface 22 of envelope flap 21 in constant moving contact with the bristles 24A of brush member 24 so as to continuously apply water to the glue surface by capillary action. The water flow that brings water to the brush comes up from the bottom portion of the moistening apparatus and then travels up toward brush member 24 and then is pushed over the top of the brush to apply water to the brush bristles 24A.

The moistener includes a waste water catch tray 27 which catches water that falls by gravity from the top portion of moistener 15. This waste water is preferably pumped by pump 25 through a filter (not shown)such as a nylon mesh filter back to the water supply in reservoir number 23.

Furthermore, in accordance with the features of the invention, a lever or controller can be activated so that an envelope flap moving within the system would not be exposed to the moistener. This would be done when envelopes were not intended to be moistened and sealed in the mailing machine. When this happens the envelope(s) and flap(s) in question would both pass through the system on the top portion of the moistening apparatus and therefore not be subject to be moistened.

In accordance with the features of the present invention there is a primary goal of the present invention to have a plurality of capillary canals to continuously supply a moistening device with the quantity of water that is needed to moisten envelopes. The size of the canals is determined by what is referred to as the Bond number. When the Bond number is under 1, it basically means that the capillary effect is preponderant compared to the gravitational forces and eventual external pressure. With external pressure, the Bond number is below 1 when the size of the canal is under 3 mm.

In real terms, the external pressure is not zero and is equal to the pressure at the water input of the moistening device. In accordance with the features of the present invention this pressure is adjusted in order to control the water flow through the moistening head. This can be done by both a reduction of the section of the input water tube and adjustment of the voltage on the water pump motor. In any event, sufficient pressure is used with the water supply to be able to continuously supply water to the brush elements.

Material requirements for a moistening head in accordance with the present invention include: (i) good capillary effect; (ii) a surface that must be resistant to wear; (iii) to be able to deliver, by means of both capillary and external water pressure, a continuous water flow through this material with a diffusion speed of V diff=3.4 mm/sec (Diffusion speed needed for a 50 um water film under the head at the standard speed of the machine); (iv) dimensions of the moistening head: 10 mm×100 mm×2 mm; (v) a diffusion speed that can be adjusted by the variation of external water pressure; and (vi) good elasticity in order that the contact surface would be able to follow small geometrical variations in the moistening surface.

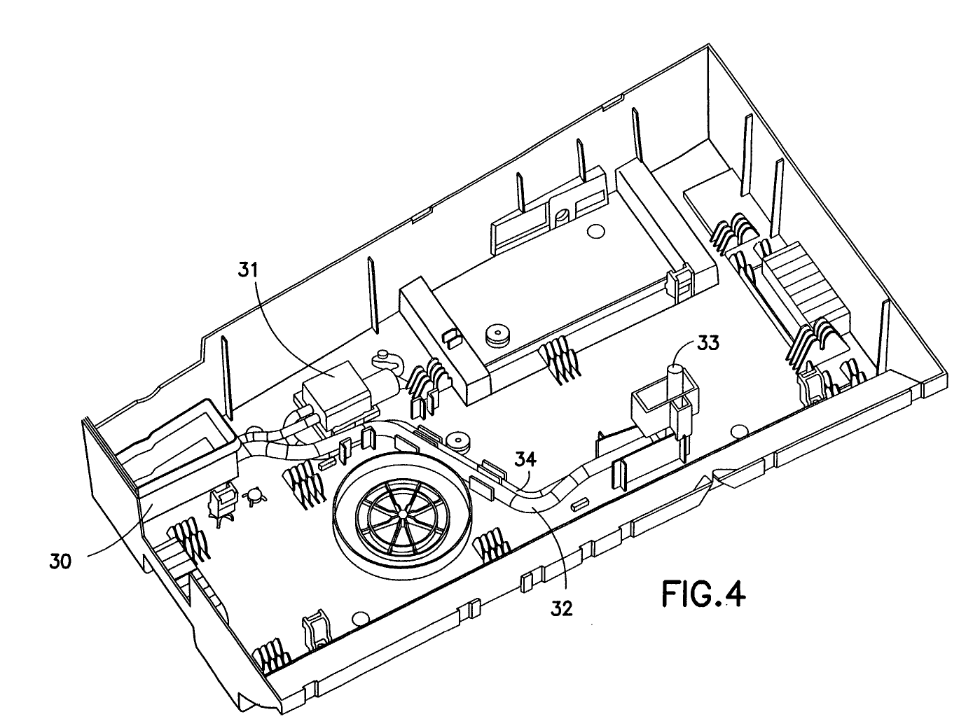

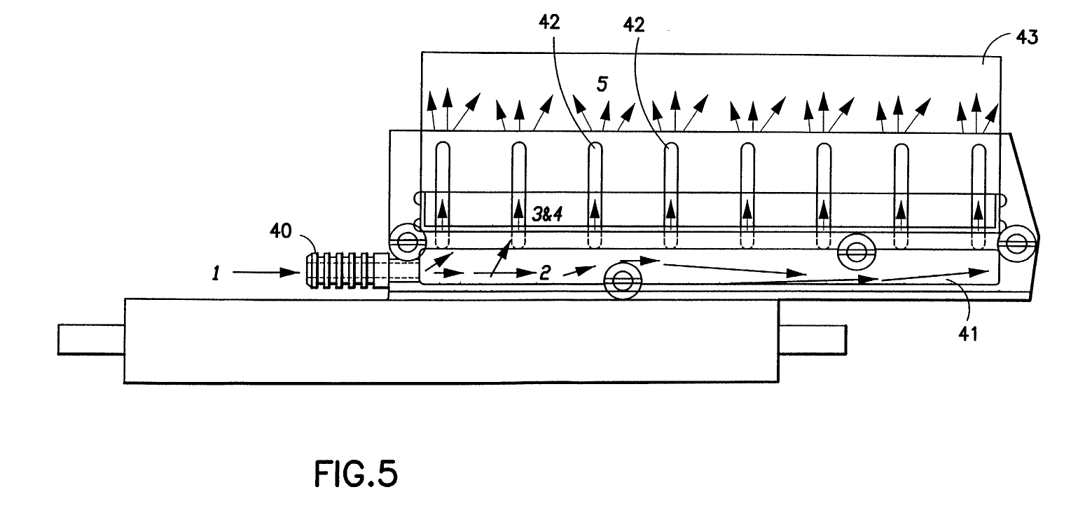

As illustrated in FIG. 4, water in the moistening apparatus of the present invention is continuously fed to the glue area of an envelope flap by starting from a reservoir tank 30 which holds a supply of water. The water is fed from reservoir tank 30 due to the pressure supplied by pump 31 through water tube 34 to the bottom portion of the moistening apparatus at location 33. Return tube 32 provides the means by which unused water is returned back to reservoir tank 30.

In operation, water is taken from the reservoir tank 30 and brought over to the moistener by the smaller pipe 34 underneath the large pipe 32. The water is pumped to the brush member in the moistener by pump 31. The water is pushed up to the moistener from below. Excess water is then collected off the moisture and brought into a back flow connection and passed back to the reservoir tank 30 through the top pipe 32.

An example of the features of the type of water pump that can be used with the moistener as described herein are features as would be determined for applying a 50 mm water film on the glued part of the envelopes.

Typical Water Pump

| | |
|---|---|
| Minimum volume flow: | 0.15 1/min |
| Maximal volume flow: | 0.3 1/min |
| Working pressure: | 0.05 bars (39 mm Hg) |
| Maximal pressure: | 0.1 bar (77 mm Hg) |
| Self prime lift (dry): | 300 mm |
| Power supply: | 6 to 12 V DC |
| Maximal volume: | 69 cm³ |
| ID of the tube: | 2 mm |
| Conditions: | 4° C. to 45° C./5 to 95% rel. |
| | humidity |
| Life time: | approx. 200 hours (per 2 |
| | million envelopes) |

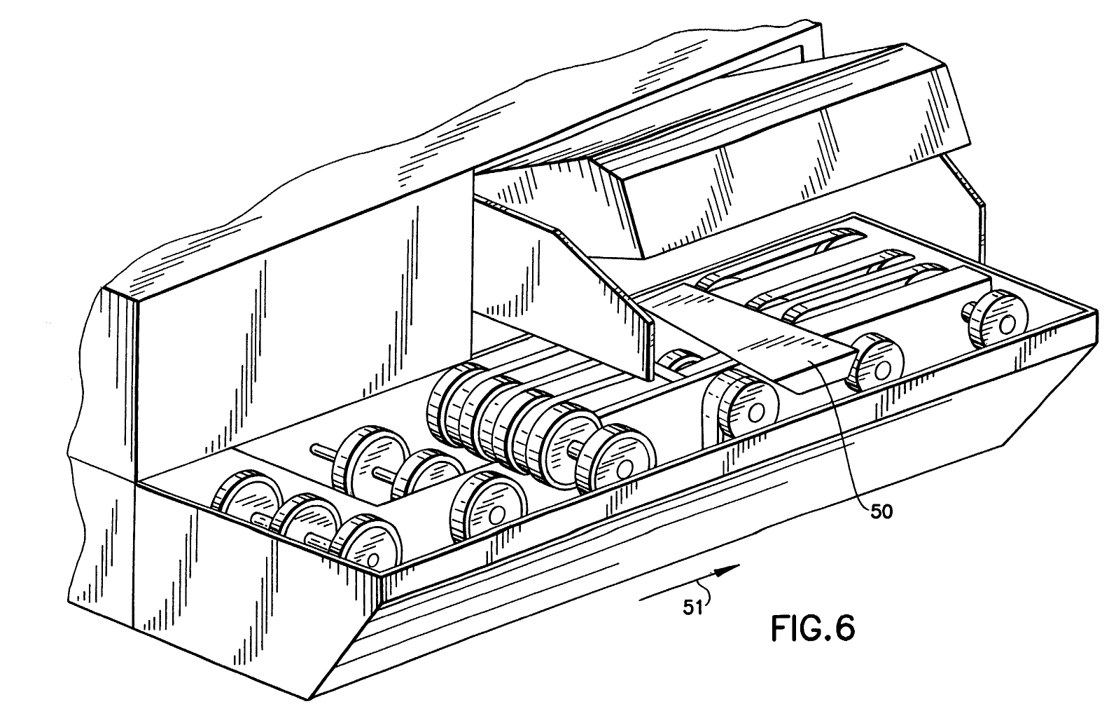

FIG. 5 illustrates the water flow pattern of a typical moistener apparatus in accordance with the features of the present invention from the water at the input to the water flow at the moistening brush. The capillary canals have a size of about 1 mm.

The main steps of the process from the entry of the water to the output through the brush as illustrated in FIG. 5 are:

At (1) in FIG. 5, the water enters the input tube 40.

At (2) in FIG. 5, the water arrives in the distribution reservoir 41 and fills it very rapidly.

At (3) in FIG. 5 the water reaches the level of the capillary canals (nozzles) 42 and begins to flow through them.

At (4) in FIG. 5, contact occurs between the water and the brush in several spots at the same time.

At (5) the water, by mean of the capillary forces and reservoir pressure, flows along the brush 43 until it reaches the moistening surface. When the system is turned on for the first time, or after

a long time of not being used, a short lap of time is necessary (approx. 5 sec) before the water reaches the moistening head. The exact amount of time depends on the water flow of the pump.

FIG. 6 basically illustrates how a moistener apparatus 50 is positioned within a mailing machine module including a series of belts that permit envelopes to be fed in the direction of arrow 51. The brush bristles of the moistener are located downstream on the moistener apparatus.

While this invention has been described in conjunction with the exemplary embodiments outlined above, it is evident that many alternatives, modifications and variations will be apparent to those of ordinary skill in the art. Accordingly, the exemplary embodiments of the invention, as set forth above, are intended to be illustrative, and not limiting. Various changes may be made without departing from the spirit and scope of the invention.

What is claimed is:

1. A moistening apparatus for moistening an area containing glue on an envelope flap by continuously supplying water to the glue area comprising:
a frame member;
a support member for moving one envelope at a time with the envelope flap in a partially opened position toward the moistening apparatus;
a brush member supported lengthwise within the frame member;
and, a water supply member in contiguous contact with the brush member and adapted to continuously moisten the entire length of the brush with water.

2. A moistening apparatus according to claim 1 further comprising a water waste catch tray positioned under said envelope flap support member.

3. A moistening apparatus according to claim 1 wherein said water supply member includes a plurality of openings for transferring said water to said brush member.

4. A moistening apparatus according to claim 3, wherein said openings are nozzles.

5. A moistening apparatus according to claim 1 wherein said water is transferred by said brush to said glue area by capillary action.

6. A moistening apparatus according to claim 1, wherein said envelope support member is in the form of a felt pad element.

7. A moistening apparatus according to claim 1 further comprising control device for controlling the supply of said water supplied to said water supply member.

8. A moistening apparatus according to claim 7, wherein said control device is an electronic control device.

9. A moistening apparatus according to claim 1 further comprising a detecting device for detecting a low level of water in said reservoir.

10. A moistening apparatus according to claim 1, wherein said area of glue on said envelope is positioned along a substantially uniform area along the edge portion of said flap.

11. A moistening apparatus according to claim 1 wherein said brush member is formed of a plurality of brush bristles, the brush bristles being substantially parallel to the path of travel of said envelopes.

12. A moistening apparatus according to claim 1 wherein said brush member is a felt material.

13. A moistening apparatus according to claim 1 wherein said brush member is a sponge material.

14. A moistening apparatus according to claim 1 wherein said brush member is formed of a plurality of brushes.

15. A moistening apparatus according to claim 1 further comprising a plurality of upper and lower belt members, the belt members adapted to press against said envelope, thereby sealing said envelopes while transporting said envelope away from said moistening apparatus.

16. A moistening apparatus according to claim 2 further comprising a filter means positioned in the flow of said excess water from said waste water catch tray to said water supply member.

17. A moistening apparatus according to claim 16 wherein said filter is formed of a nylon mesh.

18. A moistening apparatus according to claim 1 further comprising a pumping device to pump said water from a reservoir tank to said water supply member.

19. A moistening apparatus according to claim 1 wherein said brush member is adapted to position elongated portions of said brush member to moisten said glue.

20. A moistening apparatus for moistening an area containing glue on an envelope flap by continuously supplying water to the glue area comprising:
a frame member;
a support member for moving one envelope at a time with the envelope flap in a partially opened position toward the moistening apparatus;
a brush member supported lengthwise within the frame member adapted to position elongated portions of the brush to moisten the glue;
a water supply member in contiguous contact with the brush member and adapted to continuously supply the entire length of the brush with water; and a
pumping device to pump water from a reservoir tank to the water supply member.

21. A mailing machine comprising a plurality of processing stations including a processing station for transporting an envelope and a processing station for sealing the envelope, the mailing machine including a moistening apparatus for moistening the area containing glue on an envelope flap in the processing station prior to sealing the envelope, the moistening apparatus comprising:
a frame member;
a support member for moving one envelope at a time with the envelope flap in a partially opened position toward the moistening apparatus;
a brush member supported lengthwise within the frame member; and
a water supply member in contiguous contact with the brush member and adapted to continuously moisten the entire length of the brush with water; the mailing machine including
an envelope flap support element positioned under the brush member and adapted to force the glue area of the envelope flap against the moist brush member as the envelope moves through the moistening apparatus thereby supplying moisture to the entire length of the glue area on the envelope flap.

22. A mailing machine in accordance with claim 21 wherein said mailing machine is a modular mailing machine formed of at least two separate modules.

23. A mailing machine in accordance with claim 21 wherein one of said processing stations is a postage meter for applying a postal indicia on said envelope.

24. A mailing machine in accordance with claim 21 wherein said moistening apparatus further comprises a pumping device to pump water from a reservoir tank to said water supply member.

25. A mailing machine in accordance with claim 21 wherein said brush member is adapted to position elongated portions of said brush to moisten said glue.

26. A mailing machine in accordance with claim 21 further comprising a device to prevent said envelope from being in an opened position.
